(19) United States
(12) Patent Application Publication
(10) Pub. No.: US 2008/0046381 A1
(43) Pub. Date: Feb. 21, 2008

(54) ELECTRONIC PAYMENT TERMINAL AND METHOD FOR MAKING ELECTRONIC PAYMENT TERMINALS AVAILABLE

(75) Inventor: David Naccache, Paris (FR)

Correspondence Address: MARSH, FISCHMANN & BREYFOGLE LLP, 3151 SOUTH VAUGHN WAY, SUITE 411, AURORA, CO, 80014, US

(73) Assignee: INGENICO, Neuilly-Sur-Seine (FR)

(21) Appl. No.: 11/839,680

(22) Filed: Aug. 16, 2007

(30) Foreign Application Priority Data
Aug. 17, 2006 (FR) 06 07 350

(51) Int. Cl. H04L 9/00

(52) U.S. Cl. 705/73; 235/380; 705/43

(57) ABSTRACT

The invention relates to an electronic payment terminal, comprising: receiving means for receiving location data; a central processing unit planned for storing location data which may be received by the receiving means; and a program, stored in the central processing unit, for configuring the terminal on according to the location data storable in the central processing unit. The invention also relates to a method for making available, then if appropriate reallocating, electronic payment terminals such as the above.

The present invention relates to payment terminals and, in particular, setting the parameters of such terminals. It relates moreover to a method for making electronic payment terminals available.

An electronic payment terminal (EPT) is an electronic device which allows a protected payment transaction to be logged. An EPT is typically a computer installed on a trader's premises, which allows payments by bank cards (such as chip cards or magnetic strip cards). The trader inserts the client's card into the terminal card reader and enters the amount of the transaction. The client validates his purchase, for example by composing his confidential code on the keyboard of the device, and receives a receipt confirming the transaction.

Certain EPTs are portable; they include in particular a chip card reader, means of printing a receipt, a modem, and a GSM card. They are used in particular in taxis, markets, or for home delivery.

These EPTs are often connected at the traders' premises to a means of management (for example a cash register) which provides for the point of sale management. The system EPT/means of management constitutes a point of sale terminal (PST). Certain EPTs comprise a portable part for reading chip cards and printing receipts. This part rests on a base when it is not in use, and communicates with this base by a wireless link, for example a radio link, when being used. The base can be connected to the means of management; it typically comprises a modem allowing debit authorisations to be obtained from authorised agencies.

A problem arises when it is desired to make a number of payment terminals (for example for rental) available to traders in different countries or regions in which the settings (language, VAT rate, etc.) used by the terminals are different. In fact, a specific software configuration is necessary for each separate geographical area.

Thus the purpose of the invention is to simplify the configuration of these terminals. Moreover, the solution according to the invention should preferably propose a system which deters payment terminal theft.

Thus the object of the invention is an electronic payment terminal, comprising:
receiving means for receiving location data;
a central processing unit for storing the location data which may be received by the receiving means; and
a program, stored in the central processing unit, for configuring the terminal according to the location data which may be stored in the central processing unit.

In preferred embodiments, the invention comprises one or more of the following features:
the payment terminal according to the invention also comprises: a communications module, preferably GSM/GPRS, comprising the receiving means, these receiving means being designed for receiving a SIM card comprising the location data;
the receiving means are means for radio linking with an external device designed for transmitting the location data;
the external device is a satellite global positioning device;
the external device is a mobile phone;
the program is designed for configuring the terminal by making adjustments according to the location data of the following: the telephony settings; at least one tax rate; and a language setting;
the program is designed for preventing normal operation of the terminal in the case of non-correspondence of the location data which may be stored in the central processing unit with the reference location data; and
the program is designed for requesting the input of an authenticator corresponding to the reference location data if it detects a change in the data which may be received by the receiving means.

The invention also relates to the use of the payment terminal according to the invention for renting out the terminal to a third party.

The invention also relates to a method of making available terminals for electronic payment, comprising the steps of:
storing electronic payment terminals, each one according to the invention;
supplying these terminals in different geographical regions; and
configuring the terminals via execution of their respective configuration program.
   As a variant, this method also comprises the steps of:
reallocating at least one part of the terminals; and
reconfiguring the terminals of said part via execution of their respective configuration program.

Other features and advantages of the invention will become apparent on reading the following detailed description of the embodiments of the invention, given by way of example only.

The invention proposes, among other things, an electronic payment terminal, comprising a program, stored in the central processing unit of the terminal, for configuring the terminal according to location data accessible to the terminal. Thus, only one software configuration is necessary, irrespective of the geographical area in which the terminal is to be made available.

The EPT according to the invention comprises firstly, receiving means for receiving location data. Such location data are for example supplied by a SIM (Subscriber Identity Module) card. The receiving means for receiving location data are in this case a physical connection of a communications module designed for accepting a SIM card.

This SIM card is a chip card comprising a memory and a microcontroller, which allows storage of information specific to the subscriber of a network of the GSM type. The memory is typically organised in directories and files comprising in particular an identifier of the operator and the data associated with the network. The settings necessary for configuration of the EPT can for example be correlated to the geographical data contained in the SIM card in the EF_{LOCI} file (LOCI stands for “location information”). The format of this file being described in section 10.2.17 of the Digital cellular telecommunications system (Phase 2+); Specification of the Subscriber Identity Module-Mobile Equipment (SIM-ME) interface (GSM 11.11) ICS: 33.060.50, version 5.0.0 of December 1995, published by the European Telecommunications Standards Institute.

Moreover, the EPT comprises a central processing unit. The central processing unit performs the usual functions, such as control of program execution or resource allocation. It is also intended to store the location data which may be received by the receiving means.

The terminal also comprises a program, stored in the central processing unit, for configuring the terminal according to the location data. Thus, during its execution, this program controls the reading of the location data and configures the terminal accordingly. In particular, it adjusts one or more settings which may vary according to the geographical allocation of the EPT.

For this purpose, the program reads the location data which may be stored in the central processing unit. It can then for example compare this data (or the data obtained from the latter) to a data set represented in a table. Having identified the relevant location data in the table, it then identifies the settings corresponding to these latter in the table. These settings are then used for the configuration of the terminal.

Such settings can be information regarding language, character set, territorially applicable tax or VAT rates, etc. It is also possible, once the location information is detected, for the terminal to make contact (via GPRS or by any other means) with a server designated in advance. Once the connection is established, the terminal transmits its geographical location data to the server and the server transmits to the terminal the correct settings for the place where the terminal is located.

One single program can therefore be provided for storage in the EPT, regardless of the subsequent geographical allocation of the EPT. The terminals can therefore be produced by a single manufacturing process.

This is advantageous in more than one respect. For example, when a terminal is rented and then reallocated, there is no need to change the software configuration of the terminal. Similarly, a terminal initially provided to be allocated to a first geographical area can finally be made available in another zone, without requiring modifications.

In practice, when a terminal is made available, a user equips it for example with a SIM card and proceeds to configure it. The SIM card including adequate location data, configuration of the terminal is carried out according to the appropriate regional settings.

In particular, the program is designed for configuring the terminal by adjusting one or more of the following settings:
telephone number prefixes;
a tax rate, for example value added tax; and
a setting determining the language to be used (together with an associated character set, if appropriate) by the EPT for its graphical interface.
applications specific to the geographical area where the terminal is used, allowing for example, applications to be rolled out only in areas where an operating licence has been granted.

In one embodiment, the program is designed for preventing the normal operation of the terminal in the case of non-correspondence of the location data with the reference location data.

The reference location data is for example stored in the central processing unit before the terminal is allocated, according to its assumed subsequent allocation. In this case, this data is not modifiable by the user.

As a variant, it is possible to require this data to be input by the user, for example each time that a change of SIM card is detected, or more generally every time that a change of location data is detected. The user can in this case enter a confidential code, such as a personal identification number or any other authenticator, which is provided to the user by the vendor or lessor. Entering the personal identification number allows the program to compare the reference data corresponding to this authenticator with the current location data, for example the data read from the SIM card.

If the current location data (i.e. originating from the SIM) corresponds to the reference data, then the terminal is activated normally. If this is not the case, the program prevents or restricts the normal operation of the terminal.

Thus, if a terminal should be stolen or, more generally, obtained in an illicit manner, the new “user” will be obliged to change the SIM card. In this case, the program will detect incompatibility between the current data and the reference data and will block the terminal. Obtaining the EPT illicitly is thus deterred.

A example of an EPT suitable for implementation of the invention is now described.

This EPT is equipped with a GSM/GPRS communications module (dual band 900/1800 or 900/1900 MHz). The EPT comprises a four slot SIM (SIM format GSM WG 10 or three slot SIM+an available merchant card) card reader. In case of an incident on the GSM/GPRS network, an optional modem can, if necessary, ensure continued operation.

The EPT is for example equipped with a 32-bit processor running conventional cryptographic systems (RSA, DES, triple DES, etc.). The processor architecture is preferably chosen so as to allow several applications to operate independently of each other (multi-application and multi-tasking) in the device.

In this regard, the program described above can be loaded independently of the other applications provided for in the EPT, in order to ensure logic security (or unbreakable software).

A particularly suitable platform for implementing the invention is adapted from the Ingenico UNICAPT 32, platform built around a 32-bit (High Security Core (HSC) hardware module) processor including on-board security and a multi-application operating system supporting advanced programming languages such as C, C++ or JAVA. A platform of this type can be integrated into numerous environments:
Use on the move with GPRS mobile telephony or Bluetooth;
Multi-till environments using Ethernet or Wi-Fi with TCP/IP;
High sales volume traders using ADSL;
External communication by USB/PCMCIA;
Internet connection via Wi-Fi access points.

This platform (in particular its configuration program), can be modified in order to allow the implementation of features according to the invention, such as those described above.

For example, in one embodiment, the receiving means provided for in the terminal are radio link means (for example Bluetooth, infra-red or Wi-Fi, known in the art) with an external device designed for transmitting the location data.

The external device can be a satellite global positioning system (GPS) device. The GPS device, situated close to the EPT, captures the signals transmitted by the GPS system satellites and determines the latitude, the longitude and the altitude at which it is located at a particular moment, using the time indicators that these signals contain and by using computerized geographical data.

The signals transmitted by the GPS device can in this case be received by the receiving means, then stored in the central processing unit of the payment terminal. This data is then used by the program stored in the central processing unit of the EPT at the time of configuration of the terminal, as explained above.

According to a variant, a GPS chip can be integrated with the EPT, in order to give it increased independence.

It is also possible to envisage other types of position determination technology, making it possible to determine the geographical position of the EPT, for example from the radio waves emitted by a mobile phone.

The external device can thus be a mobile phone. Advantageously, the mobile phone can in this case also be used as a modem, for communicating with a payment agency. The program is then also designed for controlling the receiving means during a communication with the mobile phone.

However, the invention is not limited to the variants described above, but can be the subject of many other variations easily accessible to a person skilled in the art. As an example, it is possible to envisage applications of the invention to fixed, portable and mobile TPEs.

1. Electronic payment terminal, comprising:
receiving means for receiving location data;
a central processing unit provided for storing location data which may be received by the receiving means; and
a program, stored in the central processing unit, for configuring the terminal on the basis of the location data which may be stored in the central processing unit.

2. The payment terminal according to claim 1, further comprising:
a communications module, preferably GSM/GPRS, comprising the receiving means, these receiving means being designed for accepting a SIM card comprising the location data.

3. The payment terminal according to claim 1, in which the receiving means are means for radio linking with an external device designed for transmitting the location data.

4. The payment terminal according to claim 3, in which the external device is a satellite global positioning device.

5. The payment terminal according to claim 3, in which the external device is a mobile phone.

6. The payment terminal according to claim 1, wherein the program is designed for configuring the terminal by adjusting it according to the location data in respect of:
the telephony settings;
at least one tax rate; and
a language setting.

7. The payment terminal according to claim 1, wherein the program is designed for preventing the normal operation of the terminal in the case of non-correspondence of the location data which may be stored in the central processing unit with the reference location data.

8. The payment terminal according to claim 7, wherein the program is designed for requesting input of an authenticator corresponding to the reference location data if it detects a change in the data which may be received by the receiving means.

9. Use of the payment terminal according to claim 1, for renting out the terminal to a third party.

10. Method of making electronic payment terminals available, comprising the steps of:
storing electronic payment terminals, each according to claim 1;
supplying these terminals in different geographical regions; and
configuring the terminals via execution of their respective configuration program.

11. Method according to claim 10, further comprising the steps of:
reallocating at least one part of the terminals; and
reconfiguring the terminals of said element via execution of their respective configuration program.
